(19) United States
(12) Patent Application Publication
(10) Pub. No.: US 2021/0127722 A1
(43) Pub. Date: May 6, 2021

(54) LOW-CALORIE SOYMILK WITH REDUCED SOYBEAN ODOR

(71) Applicant: SAMYANG CORPORATION, Seoul (KR)

(72) Inventors: Hye Jin LIM, Suwon-si (KR); Bong Chan KIM, Seoul (KR); Yong-ln KIM, Yongin-si (KR); ll SEO, Gwangju-si (KR); Seung MI LEE, Hwaseong-si (KR); Su Youn LIM, Seoul (KR); Tae-Chul HAN, Hwaseong-si (KR)

(21) Appl. No.: 17/253,273

(22) PCT Filed: Mar. 11, 2019
(86) PCT No.: PCT/KR2019/002808

§ 371 Date: Dec. 17, 2020

(30) Foreign Application Priority Data
Jun. 28, 2018 (KR) 10-2018-0075043

(51) Int. Cl. A23L 11/65; A23L 33/20; A23L 27/00; A23L 33/125; A23L 29/10; A23L 29/30

(52) U.S. Cl. CPC A23L 11/65; A23L 33/20; A23L 29/30; A23L 33/125; A23L 29/10; A23L 27/84

(57) ABSTRACT

The present disclosure relates to a low-calorie, sugar-reduced soymilk comprising soybean extract solution, allulose, and soybean oil. The soymilk of the present disclosure includes allulose, and thus the soymilk has superior emulsion stability in spite of the addition of a small amount of an emulsifier and has excellent mouthfeel and taste, while having low calories than an existing product using sugar.

### TECHNICAL FIELD

The present disclosure relates to a low-calorie and redued-saccharide soymilk including raw soybean extract solution, allulose, and soybean oil. The soymilk according to the present disclosure includes allulose, and thus the soymilk has an excellent mouthfeel and taste even while having lower saccharide content and calories than general soymilk products containing sugar or fructose, and has excellent emulsion stability without adding a separate emulsifier.

### BACKGROUND ART

Soymilk is a typical processed soybean product which enhances soybean digestibility and protein utilization rate. The soymilk is well digested and absorbed, is rich in essential amino acids, contains a lot of essential fatty acids, is low in saturated fat, is free of cholesterol, and is rich in minerals such as iron, phosphorus and potassium, Therefore, the soymilk is effective in improving arteriosclerosis, lipid metabolism and nerve function, anti-aging, and breast cancer prevention by isoflavone, and can be supplied at a low price like milk, and thus, the demand therefor is increasing day by day.

In particular, since soymilk does not contain lactose, it has been recognized for its value as a high-protein milk substitute food for infants who causes lactose intolerance and allergies due to milk, and is more and more recognized as a vegetable energy drink that is beneficial for preventing adult diseases.

The biggest drawback of soymilk products is off-flavor, such as green odor or beany flavor. Consequently, consumer preference is reduced, which is a cause of hindering sales expansion in the soymilk market. The cause of off-flavor is mainly induced by the oxidation of unsaturated fatty acids by lipoxygenase, and soybean varieties lacking this enzyme have been developed to inhibit the activity of lipoxygenase, or methods of enzyme inactivation by the introduction of various types of heat treatment steps have been studied, but have limitations. These off-taste and off-flavor caused the sweetness to enhance by the excessive addition of sugar to soymilk products.

In addition, conventional soymilk products have the problem of inducing digestive disorders and adversely affecting health by excessive mixing of a vegetable oil, an emulsifier that mixes this oil and water for improving the dilute viscosity of soybean extract solution, a thickener such as carrageenan for maintaining viscosity.

To compensate for the shortcomings of these soymilk products, various techniques, such as a process of using alkaline ionized water (Korean Unexamined Patent Publication No. 2006-35841), a process of adding and fermenting lactic acid bacteria (Korean Unexamined Patent Publication No. 2011-94601), and a process of vacuum deodorization (Korean Patent Registration No. 10-1308290), have been proposed. However, the technology capable of providing a soymilk which maintains the taste and nutrition of soymilk products, reduces sugar content and calories, and maintains emulsion stability in the absence of a separate emulsifier is still not sufficient.

### DETAILED DESCRIPTION OF THE INVENTION

### Technical Problem

The present invention is to provide a low-calorie soymilk having excellent emulsion stability, including soybean extract solution, allulose, and soybean oil.

The soymilk of the present disclosure has lower saccharide content than a conventional soymilk, and contains allulose in an optimum mixing ratio, and thus has good emulsion stability, masks off-flavor peculiar to soybeans, and makes soymilk with high preference. In addition, the allulose-containing soymilk of the present disclosure provides a soymilk that does not use an emulsifier or reduces the added amount of emulsifier, or maintains emulsion stability.

### Technical Solution

Hereinafter, the present invention will be described in detail. Meanwhile, an embodiment sdisclosed below may be applied to the description and implementation of other embodimentts for the common parts, and the scope of the present disclosure is not limited by the specific embodiments described below.

According to one embodiment of the present disclosure, there is provided a low-calorie soymilk comprising soybean extract solution, allulose and soybean oil, wherein the soymilk maintains emulsion stability at a temperature of 1° C. to 10° C. for up to 115 hours, for example, between 0 and 115 hours, or between 24 and 115 hours.

According to one embodiment, the soybean extract solution refers to a soymilk liquid prepared by adding water to a bean and pulverizing it, or a soymilk obtained by separating a pureed soybean (Kongbiji) from bean, and the fresh soymilk does not contain any additives other than a soybean.

The bean may be one or more selected from the group consisting of soybean, pea, kidney bean, small bean, green moss (Seomoktae), brown soybean, white moss (Meju bean), soya bean (Glycine max (L.) Merrill), sword bean, green flesh black bean, and green soybean. Specifically, the bean of the present disclosure may be soybean. Further, the term “bean” as used herein may refer to including bean itself, crushed bean, heated bean, and crushed and heated bean.

According to some embodiments of the present disclosure, the soybean extract solution may be contained in an amount of 20% by weight to 79% by weight, 25% by weight to 79% by weight, 30% by weight to 79% by weight, 40% by weight to 79% by weight, 45% by weight to 79% by weight, 50% by weight to 79% by weight, 55% by weight to 79% by weight, 20% by weight to 75% by weight, 25% by weight to 75% by weight, 30% by weight to 75% by weight, 40% by weight to 75% by weight, 45% by weight to 75% by weight, 50% by weight to 75% by weight, 55% by weight to 75% by weight, 20% by weight to 70% by weight, 25% by weight to 70% by weight, 30% by weight to 70% by weight, 35% by weight to 70% by weight, 40% by weight to 70% by weight, 45% by weight to 70% by weight, 50% by weight to 70% by weight, 55% by weight to 70% by weight, 20% by weight to 65% by weight, 25% by weight to 65% by weight, 30% by weight to 65% by weight, 35% by weight to 65% by weight, 40% by weight to 65% by weight, 45% by weight to 65% by weight, 50% by weight to 65% by weight , 55% by weight to 65% by weight, or 57% by weight to 62% by weight, based on 100% by weight of the total soymilk

According to another embodiment, the soybean oil refers to semi-drying oil obtained from soybeans. The soybean oil is preferably used in a refined form.

The soybean oil may be contained in an amount of 0.5% by weight to 2.0% by weight, 0.7% by weight to 2.0% by weight, 0.9% by weight to 2.0% by weight, 1.0% by weight to 2.0% by weight, 1.1% by weight to 2.0% by weight, 0.5% by weight to 1.8% by weight, 0.7% by weight to 1.8% by weight, 0.9% by weight to 1.8% by weight, 1.0% by weight to 1.8% by weight, 1.1% by weight to 1.8% by weight, 0.5% by weight to 1.6% by weight, 0.7% by weight to 1.6% by weight, 0.9% by weight to 1.6% by weight, 1.0% by weight to 1.6% by weight, 0.5% by weight to 1.4% by weight, 0.7% by weight to 1.4% by weight, 0.9% by weight to 1.4% by weight, 1.0% by weight to 1.4% by weight or 1.1% by weight to 1.4% by weight, based on 100% by weight of the total soymilk.

According to some embodiments of the present disclosure, allulose contained in the soymilk may be produced by a chemical synthesis or a biological method using an allulose epimerase, preferably, by a biological method, for example, a microbial or enzyme reaction. For example, the allulose is a mixed saccharide or obtained therefrom, and the mixed saccharide may be mixed saccharide prepared by reacting a composition for producing allulose comprising one or more selected from the group consisting of allulose epimerase, a microbial cell of a strain producing the epimerase, a culture of the strain, a lysate of the microbial cell, and an extract of the lysate or culture with a fructose-containing raw material, or obtained therefrom.

The allulose contained in the fruit vegetable drink of the present disclosure may be in a form of syrup or powder. The allulose syrup may be a solution prepared using allulose at a variety of concentrations, and the solid allulose in the allulose syrup may be contained in an amount of 10 to 100% by weight based on 100% by weight of the allulose syrup, and it may be prepared by mixing, preferably, 70 to 99% by weight, more preferably, 90 to 99.99% by weight. When using the allulose powder, the allulose powder solid may use the total composition powder, for example, allulose having a purity of 90% or more, for example the allulose powder containing 90 to 99.99% by weight, more preferably 95 to 99.99% by weight of allulose.

The allulose syrup may be obtained through separation, purification and concentration processes from the allulose only or mixed saccharide. In one example of the present disclosure, the allulose syrup that has undergone the separation and purification processes may be a liquid allulose syrup which has an electrical conductivity of 1 to 50 μS/cm, is colorless or light-yellow, and has sweetness.

As one example for preparation of allulose of the present disclosure, an expression system which can produce allulose epimerase with high expression rate and stability, a GRAS (Generally recognized as safe) microorganism using the same, and a method of producing allulose containing a microorganism and enzyme using the expression system, etc. are described in detail in Korean Patent Registration No. 10-1318422 and No. 10-1656063, and the like.

The allulose may be allulose alone or a mixed saccharide containing additional other saccharides, and the example of the mixed saccharide may contain 1 to 99.9% by weight of allulose based on 100% by weight of the solid content of the total mixed saccharide, and may further contain one or more selected from the group consisting of fructose and glucose. When the allulose mixed saccharide contains fructose and/or glucose, the mixed saccharide may contain 1 to 90% by weight of fructose and/or 1 to 50% by weight of glucose.

Specific examples of the allulose-containing mixed saccharide include 5 to 30 parts by weight of allulose, 20 to 50 parts by weight of fructose and 20 to 55 parts by weight of glucose, and 1 to 10 parts by weight of oligosaccharide based on 100 parts by weight of the total solid content of the mixed saccharide, and it may not contain oligosaccharide. The allulose, fructose and glucose all are preferably D-isomers.

The allulose contained in the soymilk of the present disclosure may be in a form of syrup or powder, preferably in the form of powder. When using the allulose powder, the allulose powder solid may use the total composition powder, for example, allulose having a purity of 90% or more, for example allulose powder containing 90 to 99.99% by weight, more preferably 95 to 99.99% by weight of allulose.

The content of allulose may be 1.0% by weight to 20% by weight, 1.2% by weight to 20% by weight, 1.4% by weight to 20% by weight, 1.6% by weight to 20% by weight, 1.8% by weight to 20% by weight, 2.0% by weight to 20% by weight, 2.2% by weight to 20% by weight, 2.4% by weight to 20% by weight, 1.0% by weight to 18% by weight, 1.2% by weight to 18% by weight, 1.4% by weight to 18% by weight, 1.6% by weight to 18% by weight, 1.8% by weight to 18% by weight, 2.0% by weight to 18% by weight, 2.2% by weight to 18% by weight, 1.0% by weight to 16% by weight, 1.2% by weight to 16% by weight, 1.4% by weight to 16% by weight, 1.6% by weight to 16% by weight, 1.8% by weight to 16% by weight, 2.0% by weight to 16% by weight, 2.2% by weight to 16% by weight, 1.2% by weight to 14% by weight, 1.4% by weight to 14% by weight, 1.6% by weight to 14% by weight, 1.8% by weight to 14% by weight, 2.0% by weight to 14% by weight, 2.2% by weight to 14% by weight, 1.2% by weight to 12% by weight, 1.4% by weight to 12% by weight, 1.6% by weight to 12% by weight, 1.8% by weight to 12% by weight, 2.0% by weight to 12% by weight, 2.2% by weight to 12% by weight, 3.0% by weight to 12% by weight, 4.0% by weight to 12% by weight, 4.0% by weight to 11% by weight, or 4.2% by weight to 11% by weight, based on 100% by weight of the total soymilk

According to another embodiment of the present disclosure, the content of allulose may be 2.0 parts by weight to 40 parts by weight, 2.0 parts by weight to 38 parts by weight, 2.0 parts by weight to 36 parts by weight, 2.0 parts by weight to 34 parts by weight, 2.0 parts by weight to 32 parts by weight, 2.0 parts by weight to 30 parts by weight, 2.0 parts by weight to 28 parts by weight, 2.0 parts by weight to 26 parts by weight, 2.0 parts by weight to 24 parts by weight, 2.0 parts by weight to 22 parts by weight, 2.0 parts by weight to 20 parts by weight, 2.0 parts by weight to 18 parts by weight, 2.0 parts by weight to 17 parts by weight, 3.0 parts by weight to 40 parts by weight, 3.0 parts by weight to 38 parts by weight, 3.0 parts by weight to 36 parts by weight, 3.0 parts by weight to 34 parts by weight, 3.0 parts by weight to 32 parts by weight, 3.0 parts by weight to 30 parts by weight, 3.0 parts by weight to 28 parts by weight, 3.0 parts by weight to 26 parts by weight, 3.0 parts by weight to 24 parts by weight, 3.0 parts by weight to 22 parts by weight, 3.0 parts by weight to 20 parts by weight, 3.0 parts by weight to 18 parts by weight, 3.0 parts by weight to 17 parts by weight, 4.0 parts by weight to 40 parts by weight, 4.0 parts by weight to 38 parts by weight, 4.0 parts by weight to 36 parts by weight, 4.0 parts by weight to 34 parts by weight, 4.0 parts by weight to 32 parts by weight, 4.0 parts by weight to 30 parts by weight, 4.0 parts by weight to 28 parts by weight, 4.0 parts by weight to 26 parts by weight, 4.0 parts by weight to 24 parts by weight, 4.0 parts by weight to 22 parts by weight, 4.0 parts by weight to 20 parts by weight, 4.0 parts by weight to 18 parts by weight, 4.0 parts by weight to 17 parts by weight, 5.0 parts by weight to 17 parts by weight, 6.0 parts by weight to 17 parts by weight or 7.0 parts by weight to 17 parts by weight, based on 100 parts by weight of the soybean extract solution.

According to an embodiment of the present disclosure, the low-calorie soymilk of the present disclosure including soybean extract solution, soybean oil and allulose can maintain emulsion stability at a temperature of 1° C. to 10° C., for up to 90 hours, for example, up to 95 hours, up to 100 hours, up to 110 hours, or up to 115 hours, and preferably maintains emulsion stability for up to 115 hours. Alternatively, the time during which the emulsion stability is maintained may be 12 hours or more, 24 hours or more, 36 hours or more, or 48 hours or more. The time may be, for example, between 0 and 90 hours, between 12 and 90 hours, between 24 and 90 hours, between 36 and 90 hours, between 0 and 95 hours, between 12 and 95 hours, between 24 and 95 hours, between 36 and 95 hours, between 0 and 100 hours, between 12 and 100 hours, between 24 and 100 hours, between 36 and 100 hours, between 0 and 110 hours, between 12 and 110 hours, between 24 and 110 hours, between 36 and 110 hours, between 0 and 115 hours, between 12 and 115 hours, between 24 and 115 hours, or between 36 and 115 hours. The 0 hours may be the starting point of the emulsion stability experiment, and thus may exceed 0 hours.

Specifically, when the soymilk of the present disclosure is stored at 1° C. to 10° C., more preferably for less than 115 hours, phase separation between water and oil does not occur, and emulsion stability can be maintained.

The emulsion stability refers to a state in which two liquids that are not mixed with each other are dispersed in another liquid in the form of fine particles, and thus, the two liquids are not separated in an emulsified form and the mixed state is maintained. According to one embodiment of the present disclosure, the storage temperature may be 1° C. to 10° C., 2° C. to 8° C., 3° C. to 7° C. or 3° C. to 6° C., for example 4° C.

Specifically, as a result of measuring the emulsion stability while storing the allulose-containing soymilk of the present disclosure at about 4° C. for 5 days, no phase separation occurred for 120 hours (5 days) from the start of storage. In particular, the allulose-containing soymilk, which does not contain any emulsifier, maintained a similar degree of emulsion stability as compared with other soymilk containing an emulsifier even after storage for 120 hours (5 days). That is, the allulose-containing soymilk of the present disclosure can maintain the emuslion stability and reduce the amount of the emulsifier used even when the emulsifier is not separately contained.

The soymilk of the present disclosure may not contain an emulsifier, and may contain a small amount of an emulsifier.

According to one embodiment of the present disclosure, when an emulsifier is contained in the soymilk, the emulsifier may be contained in an amount of 0.01% to 0.3%, 0.01% to 0.2%, 0.01% to 0.1%, 0.05% to 0.3%, 0.05% to 0.2%, 0.05% to 0.1%, 0.07% to 0.3%, 0.07% to 0.2%, 0.07%˜0.1%, 0.08% to 0.3%, 0.08% to 0.2%, 0.08% to 0.1%, 0.09% to 0.3%, 0.09% to 0.2% or 0.09% to 0.1%, based on 100% by weight of the soymilk

Conventional soymilk products maintain the emulsion stability of soymilk by mixing an excessive amount of vegetable oil and an emulsifier that mixes this oil and water in order to improve the dilute viscosity of the soybean extract solution. However, the allulose-containing soymilk of the present disclosure maintains emulsion stability even if it contains no emulsifier or contains only a small amount of emulsifier. Therefore, the present disclosure newly revealed the emulsifying action of allulose in soymilk, can reduce the use of emulsifiers in soymilk and provide healthier and higher quality soymilk.

According to one embodiment of the present disclosure, a low-calorie soymilk can be provided. The soymilk of the present disclosure may have a calorie of 60 kcal or less, 55 kcal or less, or 50 kcal or less based on 100 ml. For example, it has a calorie of 10 kcal to 60 kcal, 10 to 55 kcal, preferably 10 kcal to 50 kcal, more preferably 10 kcal to 45 kcal.

According to one specific embodiment of the present disclosure, the allulose-containing soymilk of the present disclosure has a sugar content of 10 to 20 brix, preferably 10 to 18 brix, more preferably 10 to 17 brixs.

According to one embodiment of the present disclosure, the present disclosure provides a soymilk including 20 to 79% by weight of raw soybean extract solution, 0.50 to 2.0% by weight of soybean oil, 1.0 to 20.0% by weight of allulose, and a remaining amount of water, based on 100% by weight of the total soymilk.

The preferred content range of the soybean extract solution, the soybean oil, and allulose is as described above.

Conventional soymilk products enhance the sweetness by adding excessive sugar in order to mask the off-taste and off-flavor peculiar to soybeans. As a result, even if off-taste and off-flavor are partially masked, there is a problem that calories are high. However, the soymilk of the present disclosure contains allulose instead of sugar, and contains soybean extract solution and soybean oil in an optimum ratio, whereby it masks the off-taste and off-flavor peculiar to soybeans, and at the same time, maintains an appropriate sugar content, has an excellent sweetness, has an excellent consumer sensory preference and is significantly lower in calories than commercial products.

According to one embodiment of the present disclosure, the soymilk of the present disclosure contains allulose, and thereby, as a result of color difference analysis, a dark yellow soymilk having a high yellowness can be provided (see Experimental Example 3). As the allulose content in the soymilk of the present disclosure increases, the L value (lightness), the a value (redness) indicating redness (−) and green (+), and the b value (yellowness) indicating yellowness increase as a whole. The soymilk of the present disclosure has a color difference of ΔE (E*ab=_{[(ΔL*)}²+(Δa*)²+(Δb*)²]^{1/2}) of 98 or more, preferably 98.3 or more, and more preferably, it has a value of 98.4 or more.

According to another embodiment of the present disclosure, the soymilk may further include gums, and the gums serve to increase the viscosity of the diluted soybean extract solution. The gums can be used without any particular limitation as long as they are gums commonly used in commercially available beverage foods, but preferably, it is appropriate to use xanthan gum or carrageenan or a mixture of both. More preferably, it is preferred to use carrageenan to prevent protein coagulation.

Further, in the present disclosure, flavoring agents, nutrients, vitamins, electrolytes, flavor organic acid or salt thereof, pH adjusting agents, stabilizers, and the like can be added alone or in combination, if necessary. At this time, the flavoring agents, nutrients, vitamins, electrolytes, flavor organic acid or salt thereof, pH adjusting agents, stabilizers, and the like may be appropriately selected and used by those skilled in the art.

One embodiment of the present disclosure provides a method for producing a low-calorie soymilk, including the steps of: mixing soybean oil and purified water, adding and mixing soybean extract solution, and adding and mixing allulose.

In the step of mixing the soybean oil and the purified water, gums or/and an emulsifier may be further added, and the step is preferably performed by mixing them at 50° C. to 90° C., preferably 60° C. to 80° C., for example 70° C. to 75° C., and homogenization (250, 50 bar).

The step of adding and mixing soybean extract solution, and the step of adding and mixing allulose are also preferably performed by mixing at 50° C. to 90° C., preferably 60° C. to 80° C., for example 70° C. to 75° C.

Subsequently, it can go through a further sterilization process, and it is appropriate that the sterilization is performed at 90° C. to 110° C., preferably 90° C. to 100° C., more preferably 95° C. to 100° C., for 10 to 20 minutes, preferably 15 to 20 minutes. The sterilization may go through an HTST sterilization process.

Therefore, even if the allulose-containing low-calorie soymilk of the present disclosure contains a lower amount of emulsifier than the conventional soymilk, the emulsion stability is maintained, for example, the emulsion stability is maintained 115 hours at a temperature of 1° C. to 10° C. for 115 hours

In addition, the soymilk of the present disclosure is a dark yellow, has excellent taste and flavor by masking the off-taste and off-flavor of beans, and has a low calorie, threby satisfying the health need and preference of consumers.

### Advantageous Effects

The low-calorie soymilk containing allulose of the present disclosure has a low sugar content and calorie, and masks a fishy taste peculiar to soybeans by the optimum blending ratio of allulose and provides a soymilk with high preference. Also provided is a soymilk that maintains emulsion stability while reducing the use of emulsifier.

### BRIEF DESCRIPTION OF THE DRAWINGS

FIG. 1 shows the results of the emulsion stability experiments performed on the soymilk prepared in Comparative Example 3 (#3-0) and Examples 3-1 (#3-1) to 3-5 (#3-5).

FIG. 2 shows an enlarged view of the degree of phase separation of each sample measured on the 5th day among the results of FIG. 1.

FIG. 3 is a graph showing the value of L measured in the color value analysis experiments of Comparative Example 6 (#Control), Comparative Example 3 (#3-0), and Examples 3-1 (#3-1) to 3-5 (#3-5).

FIG. 4 is a graph showing the value of a measured in the color value analysis experiments of Comparative Example 6 (#Control), Comparative Example 3 (#3-0), and Examples 3-1 (#3-1) to 3-5 (#3-5).

FIG. 5 is a graph showing the value of b measured in the color value analysis experiments of Comparative Example 6 (#Control), Comparative Example 3 (#3-0), and Examples 3-1 (#3-1) to 3-5 (#3-5).

### DETAILED DESCRIPTION OF THE EMBODIMENTS

Hereinafter, the present disclosure will be described in more detail with reference to examples and experimental examples, but these examples and experimental examples are for illustrative purposes only, and the scope of the present disclosure is not limited thereby.

### PREPARATION EXAMPLE 1

### Soymilk Component and Composition of Soybean Extract Solution

(1) Raw Material Components of Soymilk

The following shows the basic mixing ratio of soymilk. The used allulose powder was a product having an allulose content of 98% or more based on solid content.

TABLE 1

| | | Mixing | |
|---|---|---|---|
| Raw material | Component | ratio % | Remark |
| soybean extract | Soybean solid | 66.00 | |
| solution | content10% | | |
| White sugar | Refined sugar | 4.80 | Samyang Corporation |
| Allulose | Allulose | — | Samyang Corporation |
| powder | content(98% or | | |
| | more based on the | | |
| | solid content) | | |
| Carrageenan | gums | 0.02 | |
| Soybean oil | — | 1.20 | |
| refined salt | — | 0.14 | — |
| Almax2700 | Emulsifier | 0.07 | LSHINWELLS Co. Ltd. |
| P-1670 | Emulsifier | 0.03 | LSHINWELLS Co. Ltd. |
| Distilled water | | 27.74 | |
| Sum | | 100.00 | |

TABLE 2

| Test Group | #1 | #2 | #3 | #4 | #5 |
|---|---|---|---|---|---|
| Added amount of | 30 | 50 | 60 | 75 | 90 |
| soybean extract solution | | | | | |
| (%) | | | | | |
| Soybean solid content of | 3 | 5 | 6 | 7.5 | 9 |
| ssoybean extract | | | | | |
| solution(%) | | | | | |
| Protein content of | 1.422 | 2.37 | 2.844 | 3.555 | 4.266 |
| soybean extract solution | | | | | |
| (%) | | | | | |

(2) Setting the range of % allulose content according to the added amount of allulose powder

Table 3 below shows the actual addition amount of allulose according to the addition amount of allulose powder (solid content 98%).

TABLE 3

| Item | #1-1 | #1-2 | #1-3 | #1-4 |
|---|---|---|---|---|
| Added amount of allulose | 2.5 | 4.5 | 7.0 | 10.0 |
| powder (%) | | | | |
| Added amount of allulose | 2.45 | 4.41 | 6.86 | 9.80 |
| (%) | | | | |

### EXAMPLE 1 AND COMPARATIVE EXAMPLE 1

### Preparation of Soymilk Containing 30% of Soybean Extract Solution

As shown in Table 4, the soymilk of Comparative Example 1 containing sugar and 30% of soybean extract solution, and the soymilk of Examples 1-1 to 1-4 containing 30% of soybean extract solution and containing allulose powder instead of sugar were prepared.

Specifically, soybean oil, gums, emulsifier and purified water were added to and homogenized with sufficiently stirring at 70° C. (250, 50 bar). Next, the soybean extract solution was added to the homogenixed mixed solution and stirred, and then sugar was added, stirred and mixed at 70° C. Then, after being passed through HTST sterilization at 95° C. for 15 minutes, it was filled in Aseptic PET.

TABLE 4

| | Comparative | | | | |
|---|---|---|---|---|---|
| Raw material | Example 1 | Example1-1 | Example1-2 | Example1-3 | Example1-4 |
| soybean extract solution(T/S | 30.000 | 30.000 | 30.000 | 30.000 | 30.000 |
| 10%) | | | | | |
| White sugar | 4.500 | — | — | — | — |
| (refined sugar) | | | | | |
| Allulose powder | — | 2.500 | 4.500 | 7.000 | 10.000 |
| (98% or more based on the | | | | | |
| solid content) | | | | | |
| Carrageenan 11838 | 0.020 | 0.020 | 0.020 | 0.020 | 0.020 |
| (gums) | | | | | |
| Soybean oil | 1.200 | 1.200 | 1.200 | 1.200 | 1.200 |
| refined salt | 0.140 | 0.140 | 0.140 | 0.140 | 0.140 |
| Almax2700(Emulsifier) | 0.070 | 0.070 | 0.070 | 0.070 | 0.070 |
| P-1670(Emulsifier) | 0.030 | 0.030 | 0.030 | 0.030 | 0.030 |
| Distilled water | 64.040 | 66.040 | 64.040 | 61.540 | 58.540 |
| Sum | 100.000 | 100.000 | 100.000 | 100.000 | 100.000 |

### EXAMPLE 2 AND COMPARATIVE EXAMPLE 2

### Preparation of Soymilk Containing 50% of Soybean Extract Solution

As shown in Table 5 below, the soymilk of Comparative Example 2 containing 50% of soybean extract solution and containing sugar, and the soymilk of Examples 2-1 to 2-4 containing 50% of soybean extract solution and containing allulose powder instead of sugar were prepared. The preparation method is the same as in Example 1.

TABLE 5

| | Comparative | | | | |
|---|---|---|---|---|---|
| Raw material | Example 2 | Example 2-1 | Example 2-2 | Example 2-3 | Example 2-4 |
| soybean extract | 50.000 | 50.000 | 50.000 | 50.000 | 50.000 |
| solution | | | | | |
| White sugar | 4.500 | — | — | — | — |
| Allulose powder | — | 2.500 | 4.500 | 7.000 | 10.000 |
| Carrageenan 11838 | 0.020 | 0.020 | 0.020 | 0.020 | 0.020 |
| Soybean oil | 1.200 | 1.200 | 1.200 | 1.200 | 1.200 |
| refined salt | 0.140 | 0.140 | 0.140 | 0.140 | 0.140 |
| Almax2700 | 0.070 | 0.070 | 0.070 | 0.070 | 0.070 |
| P-1670 | 0.030 | 0.030 | 0.030 | 0.030 | 0.030 |
| Distilled water | 44.040 | 46.040 | 44.040 | 41.540 | 38.540 |
| Sum | 100. | 100 | 100 | 100 | 100 |

### EXAMPLE 3 AND COMPARATIVE EXAMPLE 3

### Preparation of Soymilk Containing 60% of Soybean Extract Solution

As shown in Table 6 below, the soymilk of Comparative Example 3 containing 60% of soybean extract solution and containing sugar, and the soymilk of Examples 3-1 to 3-5 containing 60% of soybean extract solution and containing allulose powder instead of sugar were prepared. The preparation method is the same as in Example 1. Examples 3-5 did not contain emulsifier (Almax2700, P-1670). The preparation method is the same as in Example 1.

TABLE 6

| | Compar- | Exam- | Exam- | Exam- | Exam- | Exam- |
|---|---|---|---|---|---|---|
| Raw | ative | ple | ple | ple | ple | ple |
| material | Example 3 | 3-1 | 3-2 | 3-3 | 3-4 | 3-5 |
| soybean | 60.0 | 60.0 | 60.0 | 60.0 | 60.0 | 60.0 |
| extract | | | | | | |
| solution | | | | | | |
| White sugar | 4.50 | — | — | — | — | — |
| Allulose | — | 2.5 | 4.5 | 7.0 | 10.0 | 7.0 |
| powder | | | | | | |
| Carrageenan | 0.020 | 0.020 | 0.020 | 0.020 | 0.020 | 0.020 |
| 11838 | | | | | | |
| Soybean oil | 1.200 | 1.200 | 1.200 | 1.200 | 1.200 | 1.200 |
| refined salt | 0.140 | 0.140 | 0.140 | 0.140 | 0.140 | 0.140 |
| Almax2700 | 0.070 | 0.070 | 0.070 | 0.070 | 0.070 | — |
| P-1670 | 0.030 | 0.030 | 0.030 | 0.030 | 0.030 | — |
| Distilled | 34.040 | 36.040 | 34.040 | 31.540 | 28.540 | 31.640 |
| water | | | | | | |
| Sum | 100 | 100 | 100 | 100 | 100 | 100 |

### EXAMPLE 4 AND COMPARATIVE EXAMPLE 4

### Preparation of Soymilk Containing 75% of Soybean Extract Solution

The soymilk of Comparative Example 4 containing 75% of soybean extract solution and containing sugar, and the soymilk of Examples 4-1 to 4-4 containing 75% of soybean extract solution and containing allulose powder instead of sugar were prepared.

TABLE 7

| Raw | Comparative | Example | Example | Example | Example |
|---|---|---|---|---|---|
| material | Example 4 | 4-1 | 4-2 | 4-3 | 4-4 |
| soybean | 75.000 | 75.000 | 75.000 | 75.000 | 75.000 |
| extract | | | | | |
| solution | | | | | |
| White sugar | 4.500 | — | — | — | — |
| Allulose | — | 2.500 | 4.500 | 7.000 | 10.000 |
| powder | | | | | |
| Carrageenan | 0.020 | 0.020 | 0.020 | 0.020 | 0.020 |
| 11838 | | | | | |
| Soybean oil | 1.200 | 1.200 | 1.200 | 1.200 | 1.200 |
| refined salt | 0.140 | 0.140 | 0.140 | 0.140 | 0.140 |
| Almax2700 | 0.070 | 0.070 | 0.070 | 0.070 | 0.070 |
| P-1670 | 0.030 | 0.030 | 0.030 | 0.030 | 0.030 |
| Distilled | 19.040 | 21.040 | 19.040 | 16.540 | 13.540 |
| water | | | | | |
| Sum | 100.000 | 100.000 | 100.000 | 100.000 | 100.000 |

### EXPERIMENTAL EXAMPLE 1

### Measurement of PH and Brix of Soymilk

The pH and sugar content of the soymilk of Comparative Example 5 (Vegemeal, Chungs Food) as commercially available soymilk products, and Comparative Example 3, and Examples 3-1 to 3-5, were measured. Specifically, the pH was measured using a pH meter (Methrom 780 pH meter, Switzerland), and the sugar content was measured using an Atago table brixmeter (20° C. sample analysis).

TABLE 8

| | Compar- | Compar- | | | | | |
|---|---|---|---|---|---|---|---|
| | ative | ative | Exam- | Exam- | Exam- | Exam- | Exam- |
| | Example | Exam- | ple | ple | ple | ple | ple |
| Item | 6 | ple 3 | 3-1 | 3-2 | 3-3 | 3-4 | 3-5 |
| pH | 7.28 | 6.52 | 6.54 | 6.55 | 6.55 | 6.56 | 6.57 |
| bx | 13.92 | 12.82 | 11.05 | 12.58 | 14.84 | 17.1 | 15.81 |

As a result, it was confirmed that the pH of the commercially available soymilk was at a neutral level of 6.0 to 8.0, and the soymilk according to Examples 3-1 to 3-5 of the present invention also had a similar pH.

### EXPERIMENTAL EXAMPLE 2

### Emulsion Stability Experiment of Soymilk

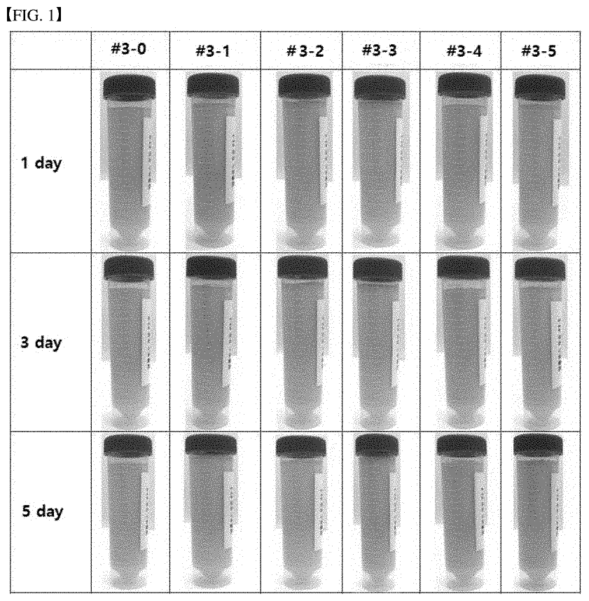

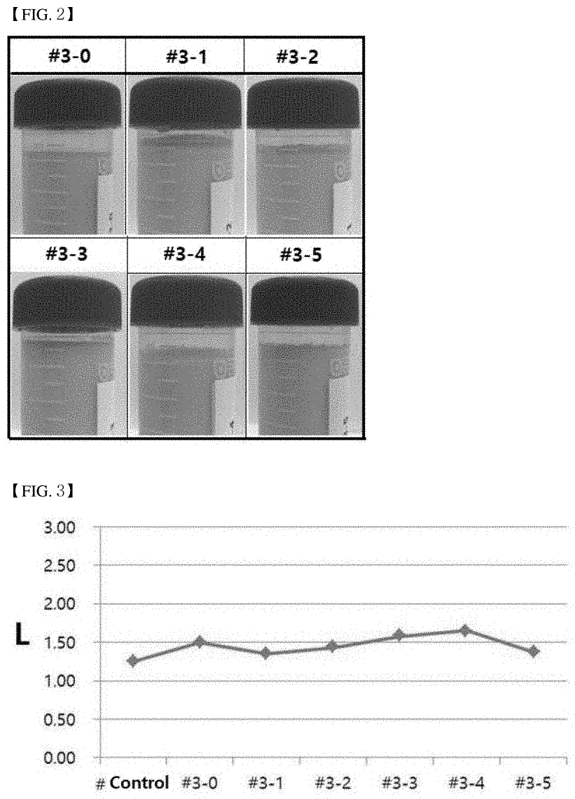

The soymilk prepared in Comparative Example 3 and Examples 3-1 to 3-5 was refrigerated and stored at 4° C. for 5 days, and then the degree of phase separation was visually compared. The results are shown in FIGS. 1 and 2.

As shown in FIGS. 1 and 2, on the fifth day of storage, only the soymilk prepared in Example 3-1 showed slight phase separation in the upper part, but the soymilk according to Examples 3-2 to 3-5 did not undergo phase separation for 5 days from the start of storage.

In addition, the soymilk containing allulose of Example 3-5 of the present disclosure does not contain an emulsifier. Even after 5 days after storage in the same manner as allulose soymilk containing the emulsifier (Example 3-3) and the soymilk according to Comparative Example 3 containing the emulsifier and sugar, phase separation did not occur, and had a similar degree of emulsion stability.

EXPERIMENTAL EXAMPLE 3

### Color Value Analysis Experiment of Soymilk

In order to confirm the change in color of soymilk according to the content of allulose, a color value analysis experiment was performed.

The chromaticity of the soymilk sample of Comparative Example 6 (Vegemeal, Chungs Food) as commercially available soymilk products, Comparative Example 3, and Examples 3-1 to 3-5, was measured using a color difference meter (CM-3500d, Konica Minolta, Osaka, Japan), and the ΔE associated therewith was calculated.

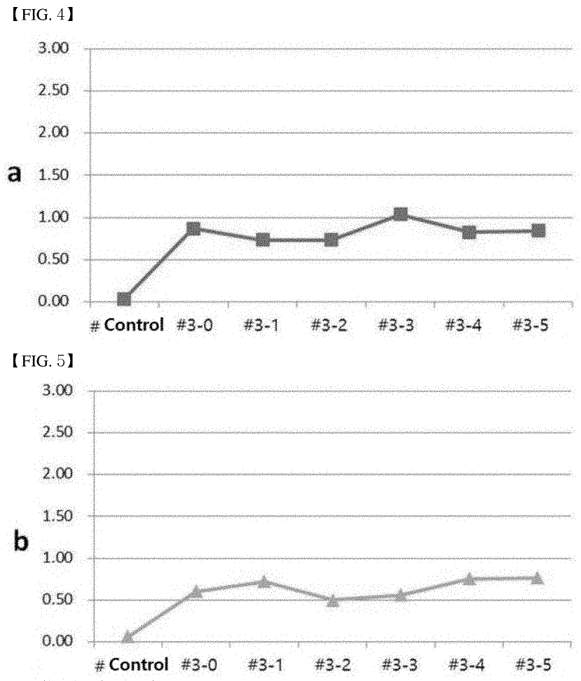

Specifically, when analyzing chromaticity, the L value indicating brightness, the a value (Redness) indicating redness (−) and greenness (+), the b value (Yellowness) indicating the degree of yellowness, and the color difference ΔE (ΔE*ab=[(ΔL*)²+(Δa*)²+(Δb*)²]^{1/2}) were measured in the first, second, and third order, and the average was measured. The results are shown in Table 9 below. The change of the L value is shown in FIG. 3, the change of the a value is shown in FIG. 4, and the change of the b value is shown in FIG. 5.

According to FIGS. 3 to 5, the L, a, and b values appeared to increase overall as the allulose content increased, confirming that this was due to the browning effect of allulose. As a result of chromaticity comparison, it was found that the higher the content of allulose in the soymilk, the higher the yellowness, so that the deeper color could be imparted to soymilk. In particular, the soymilk of Example 3-5 exhibited a yellowness similar to that of the soymilk of Comparative Example 6.

TABLE 9

| Item | | L | a | b | ΔE |
|---|---|---|---|---|---|
| Comparative | 1st | 1.23 | 0.05 | 0.07 | 98.75 |
| Example 6 | measurement | | | | |
| | 2nd | 1.27 | −0.01 | 0.06 | 98.71 |
| | measurement | | | | |
| | 3rd | 1.24 | 0.06 | 0.06 | 99.09 |
| | measurement | | | | |
| | Mean | 1.25 | 0.03 | 0.06 | 98.85 |
| Comparative | 1st | 1.55 | 0.81 | 0.60 | 98.44 |
| Example3 | measurement | | | | |
| | 2nd | 1.38 | 0.89 | 0.73 | 98.61 |
| | measurement | | | | |
| | 3rd | 1.55 | 0.90 | 0.48 | 98.45 |
| | measurement | | | | |
| | Mean | 1.49 | 0.87 | 0.60 | 98.50 |
| Example3-1 | 1st | 1.38 | 0.76 | 0.57 | 98.62 |
| | measurement | | | | |
| | 2nd | 1.40 | 0.54 | 0.78 | 98.60 |
| | measurement | | | | |
| | 3rd | 1.26 | 0.89 | 0.81 | 98.74 |
| | measurement | | | | |
| | Mean | 1.35 | 0.73 | 0.72 | 98.65 |
| Example3-2 | 1st | 1.46 | 0.69 | 0.49 | 98.53 |
| | measurement | | | | |
| | 2nd | 1.25 | 0.83 | 0.56 | 98.74 |
| | measurement | | | | |
| | 3rd | 1.59 | 0.67 | 0.44 | 98.40 |
| | measurement | | | | |
| | Mean | 1.43 | 0.73 | 0.50 | 98.56 |
| Example3-3 | 1st | 1.64 | 0.89 | 0.53 | 98.35 |
| | measurement | | | | |
| | 2nd | 1.74 | 0.93 | 0.52 | 98.25 |
| | measurement | | | | |
| | 3rd | 1.36 | 1.28 | 0.62 | 98.63 |
| | measurement | | | | |
| | Mean | 1.58 | 1.03 | 0.56 | 98.41 |
| Example3-4 | 1st | 1.66 | 0.79 | 0.78 | 98.33 |
| | measurement | | | | |
| | 2nd | 1.77 | 0.81 | 0.55 | 98.22 |
| | measurement | | | | |
| | 3rd | 1.53 | 0.88 | 0.93 | 98.47 |
| | measurement | | | | |
| | Mean | 1.65 | 0.83 | 0.75 | 98.34 |
| Example3-5 | 1st | 1.28 | 0.84 | 0.71 | 98.71 |
| | measurement | | | | |
| | 2nd | 1.38 | 0.81 | 0.81 | 98.73 |
| | measurement | | | | |
| | 3rd | 1.46 | 0.87 | 0.78 | 99.24 |
| | measurement | | | | |
| | Mean | 1.37 | 0.84 | 0.77 | 98.89 |

### EXPERIMENTAL EXAMPLE 4

### Sensory Evaluation

Sensory evaluation of the soymilk prepared in Comparative Example 3 and Examples 3-1 to 3-5 was performed. The evaluation items of color satisfaction, mouth feel (thin-thick), texture satisfaction, taste satisfaction, and overall satisfaction were evaluated based on the following evaluation criteria. The evaluation results are shown in Table 10 below. Specifically, sensory evaluation was performed on 20 adult male and female panelists in their 20s and 50s using a 5-point scale.

[Evaluation Criteria]

Color satisfaction: light color (1 point)-dark color (5 points)

mouthfeel: No and light mouth feel (1 point)-high and heavy mouth feel (5 points)

Texture satisfaction: Very bad texture (1 point)-very good texture (5 points)

Taste satisfaction: Very bad taste (1 point)-Very good taste (5 points)

Overall satisfaction: Very bad overall satisfaction (1 point)-Very good overall satisfaction (5 points)

Specifically, the color satisfaction refers to the degree of darkness and lightness

of color when the sample soymilk is observed with the naked eye, the mouth feel means the degree to which mouth feel of sample is heavy, the texture satisfaction means the degree of texture satisfaction that can be felt in the mouth, the taste satisfaction means the degree of taste satisfaction of taste that can be felt in the mouth, and the overall satisfaction means the degree of overall sensory satisfaction of the product.

TABLE 10

| soybean extract | Color | | Texture | Taste | Overall |
|---|---|---|---|---|---|
| solution % | satisfaction | Mouthfeel | satisfaction | satisfaction | satisfaction |
| Comparative | 3.2 | 2 | 3 | 3 | 2.8 |
| Example 3 | | | | | |
| Example3-1 | 3.3 | 2.1 | 3.2 | 3.2 | 3 |
| Example3-2 | 3.2 | 2.8 | 3.1 | 3.4 | 3 |
| Example3-3 | 3.6 | 3.2 | 3.1 | 3.6 | 3 |
| Example3-4 | 3.5 | 3.9 | 3.3 | 3.7 | 3.4 |
| Examp1e3-5 | 3.4 | 3.8 | 3.2 | 3.7 | 3.3 |

As shown in Table 10, the overall satisfaction of the soymilk according to Examples 3-1 to 3-5 containing allulose was higher than that of the soymilk according to Comparative Example 3 containing sugar. Specifically, the soymilk of Examples 3-1 to 3-5 was more excellent in color satisfaction, mouth feel, texture satisfaction, and taste satisfaction than Comparative Example 1

### EXPERIMENTAL EXAMPLE 5

### Comparison of Sugar Reducing Effect

In order to confirm the sugar reducing effect of the present disclosure soymilk, the calories of the soymilks according to Comparative Example 3, Example 3-1 to Example 3-5 were measured and shown in Table 11 below.

TABLE 11

| | Compar- | Exam- | Exam- | Exam- | Exam- | Exam- |
|---|---|---|---|---|---|---|
| | ative | ple | ple | ple | ple | ple |
| Item | Example 3 | 3-1 | 3-2 | 3-3 | 3-4 | 3-5 |
| Calorie | 61.64 | 43.64 | 43.64 | 43.64 | 43.64 | 43.24 |
| (kcal/ | | | | | | |
| 100 ml) | | | | | | |

As shown in Table 11, it was confirmed that the calories of the soymilk according to Examples 3-1 to 3-5 containing allulose were significantly lower than the soymilk of Comparative Example 3 containing sugar.

1. A low-calorie soymilk comprising soybean extract solution, allulose and soybean oil, and maintaining emulsion stability at a temperature of 1° C. to 10° C. for up to 115 hours.

2. The soymilk according to claim 1, wherein the soybean extract solution is contained in an amount of 20% by weight to 79% by weight based on 100% by weight of the total soymilk.

3. The soymilk according to claim 1, wherein the soybean oil is contained in an amount of 0.50% by weight to 2.0% by weight based on 100% by weight of the total soymilk.

4. The soymilk according to claim 1, wherein the allulose is an allulose powder having a solid content of 90 to 99.99% by weight of allulose.

5. The soymilk according to claim 1, wherein the allulose is contained in an amount of 1.0 to 20.0% by weight based on 100% by weight of the total soymilk.

6. The soymilk according to claim 1, wherein the allulose is contained in an amount of 2.0 parts by weight to 40 parts by weight based on 100 parts by weight of the soybean extract solution.

7. The soymilk according to claim 1, wherein the soymilk further comprises an emulsifier.

8. The soymilk according to claim 7, wherein a content of the emulsifier is 0.01% by weight to 0.3% by weight based on 100% by weight of the soymilk.

9. The soymilk according to claim 1, wherein the soymilk has a calorie of 10 kcal to 60 kcal based on 100 ml of the soymilk.

10. The soymilk according to claim 1, comprising,
20 to 79% by weight of soybean extract solution,
0.50 to 2.0% by weight of soybean oil,
1.0 to 20.0% by weight of allulose, and
a remaining amount of water,
based on 100% by weight of the total soymilk.

11. A method for producing a low-calorie soymilk, comprising the steps of mixing soybean oil and purified water, mixing with adding soybean extract solution, and mixing with adding allulose.

12. The method for producing a low-calorie soymilk according to claim 11, wherein the soymilk maintains emulsion stability at a temperature of 1° C. to 10° C. for up to 115 hours.

13. The method for producing a low-calorie soymilk according to claim 11, wherein the method for producing is performed at 50° C. to 90° C.
